(19) United States
(12) Patent Application Publication
(10) Pub. No.: US 2015/0029565 A1
(43) Pub. Date: Jan. 29, 2015

(54) DEVICE AND METHOD FOR FEEDBACK BASED DIGITAL HOLOGRAPHIC CONTENT RECONSTRUCTION VERIFICATION

(71) Applicant: Electronics and Telecommunications Research Institute, Daejeon (KR)

(72) Inventor: Wook Ho SON, Daejeon (KR)

(73) Assignee: Electronics and Telecommunications Research Institute, Daejeon (KR)

(21) Appl. No.: 14/340,001

(22) Filed: Jul. 24, 2014

(30) Foreign Application Priority Data
Jul. 26, 2013 (KR) 10-2013-0088533

(51) Int. Cl. G03H 1/08

(52) U.S. Cl. CPC G03H 1/0866; G03H 2001/0883
USPC 359/9

(57) ABSTRACT

Provided are a device and a method for feedback based digital holographic content reconstruction verification. The device may include a generator to generate a holographic content by receiving a first parameter value, a reconstructor to reconstruct a hologram from the holographic content, and a feedback based interface to adjust the first parameter value to be a second parameter value by receiving feedback on the hologram.

### CROSS-REFERENCE TO RELATED APPLICATION

This application claims the priority benefit of Korean Patent Application No. 10-2013-0088533, filed on Jul. 26, 2013, in the Korean Intellectual Property Office, the disclosure of which is incorporated herein by reference.

### BACKGROUND

1. Field of the Invention

The present invention relates to technology for generating holographic content based on a first parameter value, reconstructing a hologram from the holographic content to be displayed on a display, receiving feedback to correct the reconstructed hologram and reflecting the feedback, and verifying a play of the holographic content.

2. Description of the Related Art

A hologram may be displayed for an observer by applying a method of calculating a Computer-Generated Hologram (CGH), generating a holographic content, and applying a corresponding signal to a spatial light modulator for the holographic content.

Conventional technology may provide an optimized hologram by modifying the holographic content to be suitable for characteristics of the spatial light modulator and the observer based on a manual control. However, the manual control is limited to non-standardized offline control of a band of the holographic content and thus, may be ineffective.

Accordingly, there is a desire for technology that may define parameters used to generate holographic content, adjust the parameters based on feedback from an observer, and verify and modify the holographic content effectively.

### SUMMARY

According to embodiments of the present invention, a holographic content may be artificially generated by defining parameters based on characteristics associated with a device for reconstructing a hologram and an observer viewing the hologram and calculating parameter values.

Further, a playback of the hologram may be optimized by receiving feedback from the observer, verifying the holographic content, and adjusting the parameter values based on the feedback.

According to an aspect of the present invention, there is provided a device for feedback based digital holographic content reconstruction verification including a generator to generate a holographic content by receiving a first parameter value, a reconstructor to reconstruct a hologram from the holographic content, and a feedback based interface to adjust the first parameter value to be a second parameter value by receiving feedback on the hologram.

According to another aspect of the present invention, there is provided a method for providing feedback based digital holographic content reconstruction verification including generating a holographic content by receiving a first parameter value and calculating a Computer-Generated Hologram (CGH), reconstructing a hologram from the holographic content to be using a spatial light modulator, and adjusting the first parameter value to be a second parameter value by providing the hologram to a display and receiving feedback from the display.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of a device for digital holographic content reconstruction verification according to an embodiment of the present invention;

FIG. 2 is a diagram illustrating a configuration of a device for digital holographic content reconstruction verification according to another embodiment of the present invention;

FIG. 3 illustrates reception of feedback according to an embodiment of the present invention; and

FIG. 4 is a flowchart illustrating a method for providing digital holographic content reconstruction verification according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the accompanying drawings, however, the present invention is not limited thereto or restricted thereby.

When it is determined a detailed description related to a related known function or configuration that may make the purpose of the present invention unnecessarily ambiguous in describing the present invention, the detailed description will be omitted here. Also, terms used herein are defined to appropriately describe the exemplary embodiments of the present invention and thus may be changed depending on a user, the intent of an operator, or a custom. Accordingly, the terms must be defined based on the following overall description of this specification.

A hologram described herein may indicate an image forming a three-dimensional (3D) effect by which an observer may experience realistic viewing of an actual object while a holographic content is being played, due to diffraction and interference of light. The holographic content may indicate digital information generated by substituting each pixel value of a 3D image of the object into an equation defined in a process of modeling the hologram.

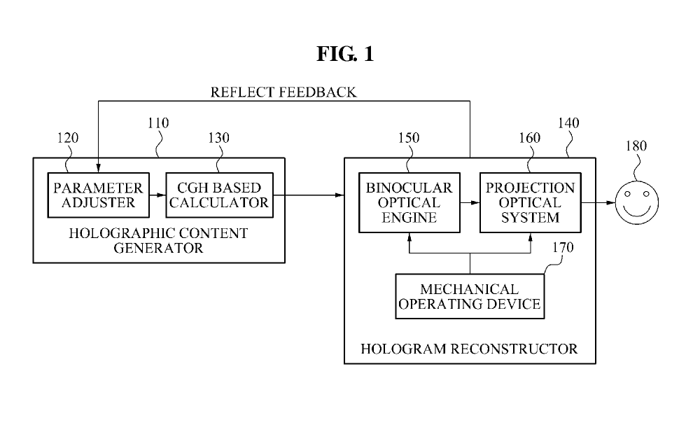

FIG. 1 is a diagram illustrating a configuration of a device for digital holographic content reconstruction verification according to an embodiment of the present invention.

Referring to FIG. 1, the device may include a holographic content generator 110 and a hologram reconstructor 140.

The holographic content generator 110 may generate a holographic content by calculating a Computer-Generated Hologram (CGH). The CGH may indicate a method of calculating each pixel value of a 3D image of an object based on an equation defined in a modeling process. The holographic content generator 110 may generate a piece of the holographic content for each pixel value by obtaining the 3D image of the object. The holographic content generator 110 may compress the holographic content calculated by a corresponding size of a pixel into one piece of the holographic content and record the compressed holographic content. The 3D image may be obtained using a stereo camera indicating depth information or graphically implemented.

Further, the holographic content generator 110 may adjust a value of a parameter provided in an equation defined by a parameter adjuster 120.

The parameter adjuster 120 may adjust a spatial light modulator parameter associated with a characteristic of a spatial light modulator optically reconstructing the holographic content, and a display parameter value associated with a characteristic of a display showing the holographic content to an observer 180.

The spatial light modulator parameter value may include an optical wavelength, a size of a hologram pixel, and a number of hologram samplings. The display parameter value may include a pixel pitch, a number of pixels, and a signal format.

A CGH based calculator 130 may generate the holographic content by calculating the equation based on the spatial light modulator parameter value and the display parameter value. The CGH based calculator 130 may calculate the equation with each pixel value of the 3D image and generate the holographic content, based on the size of the pixel, during a predetermined amount of time.

The hologram reconstructor 140 may reconstruct a hologram from the holographic content.

The hologram reconstructor 140 may play the holographic content by positioning the holographic content in a binocular optical engine 150.

The binocular optical engine 150 may include a device to inject light into eyes of the observer 180 and the spatial light modulator to modulate a signal of the incident light.

The hologram reconstructor 140 may reproduce a form of the object by playing the holographic content using an optical method of shining the light at the holographic content.

The hologram reconstructor 140 may project a laser beam into the eyes of the observer 180 and thus, the hologram may be shown. When shining the light at the holographic content, a direction of the reflected light may be equal to a direction of light reflected from the object.

The hologram reconstructor 140 may magnify the light using a projection optical system 160 based on a reflector. The binocular optical engine 150 and the projection optical system 160 may adjust the signal of the light using a mechanical operating device 170.

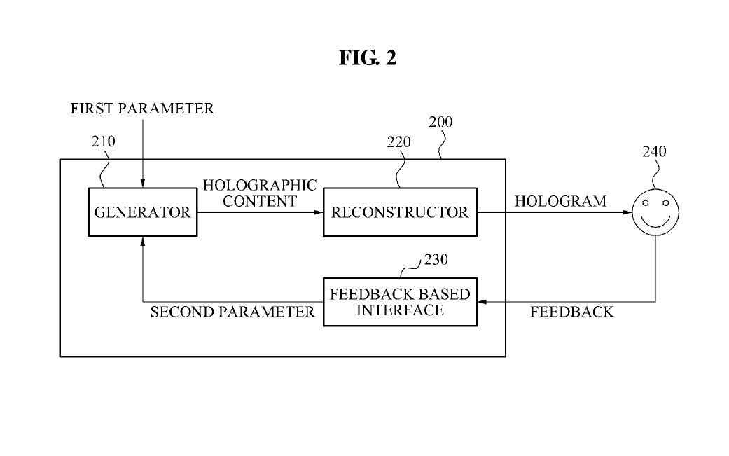

FIG. 2 is a diagram illustrating a configuration of a device 200 for digital holographic content reconstruction verification according to another embodiment of the present invention.

Referring to FIG. 2, the device 200 may include a generator 210, a reconstructor 220, and a feedback based interface 230.

The generator 210 may generate a holographic content by receiving a first parameter value and calculating a CGH. The generator 210 may obtain a 3D image of an object to be shown as a hologram and calculate the CGH. The generator 210 may calculate each pixel value of the 3D image using an equation defined by a modeling unit. The modeling unit may perform optical modeling on a change in the hologram occurring due to adjusting the first parameter value. The 3D image may be obtained using either a stereo camera, or a stereoscopic image editing tool for a virtual object.

The generator 210 may receive a spatial light modulator parameter value defining a characteristic of a spatial light modulator as the first parameter value. The spatial light modulator may be a device that may modulate a signal of light incident to the holographic content and reconstruct a hologram from the holographic content. Here, whether the hologram is displayed to an observer may be determined based on a type and a characteristic of the spatial light modulator. The spatial light modulator may electrically record the holographic content in the incident light to show the holographic content to the observer. The spatial light modulator parameter value may include an optical wavelength, a pixel size of a holographic content, and a number of holographic content samplings.

The generator 210 may receive a display parameter value defining a characteristic of a display as the first parameter value. The display parameter value may include a pixel pitch, a number of pixels, and signal format.

The generator 210 may generate the holographic content in a form of a video signal by substituting the first parameter value in the equation.

The reconstructor 220 may reconstruct the hologram from the holographic content. The reconstructor 220 may enlarge a size of the hologram based on a width between eyes of an observer 240 viewing a display and project the hologram to the eyes.

The feedback based interface 230 may adjust the first parameter value to a second parameter value by providing the hologram to the display and receiving feedback from the display. The feedback may be information on whether the holographic content calculated based on the first parameter value is played on the display, as the hologram on which modeling is performed.

The feedback based interface 230 may adjust the first parameter value by directly receiving the second parameter value of the hologram.

The feedback based interface 230 may determine items to be verified, such as, a size and image quality of the hologram, and receive information on whether the items are satisfied.

When differing feedback is received from each of a plurality of displays, the feedback based interface 230 may calculate an average of the feedback and prepare a standardized feedback to adjust the first parameter value to the second parameter value.

The feedback based interface 230 may determine, based on the feedback, whether the hologram is displayed on the display.

The feedback based interface 230 may determine, based on the feedback, whether to adjust the first parameter value to the second parameter value by determining whether the hologram provided to the display corresponds to a predetermined band of the holographic content, or a characteristic of the spatial light modulator.

For example, when the feedback based interface 230 receives feedback indicating that the hologram is not displayed, the feedback based interface 230 may determine that the band of the holographic content does not correspond to a band of the hologram.

The feedback based interface 230 may adjust the first parameter value by receiving feedback reflecting an individual characteristic of the observer 240. The feedback based interface 230 may adjust the first parameter value by receiving the individual characteristic, such as, the width between the eyes of the observer 240.

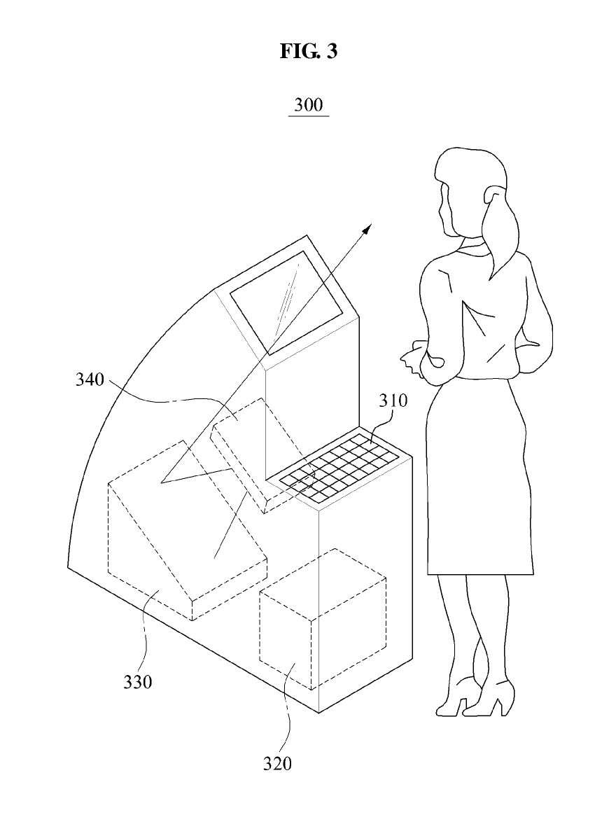

FIG. 3 illustrates reception of feedback according to an embodiment of the present invention.

Referring to FIG. 3, a device 300 for digital holographic content reconstruction verification may generate a holographic content using a first parameter value, reconstruct a hologram 320 from the holographic content, and provide the hologram on a display to an observer.

The device 300 may receive feedback on the hologram 320 from the observer, adjust the first parameter value to a second parameter value, and repeat a process of generating the holographic content.

The device 300 may include a generator to generate the holographic content and a reconstructor to reconstruct the hologram 320 from the holographic content. The generator and the reconstructor may be provided in a form of a generator and reconstructor integrated kiosk.

The device 300 may generate the holographic content by receiving the first parameter value and calculating a CGH. Here, the device 300 may generate the holographic content in a form of a video signal.

The device 300 may calculate the CGH by obtaining a 3D image of an object and substituting each pixel value of the 3D image into an equation. The device 300 may perform modeling on the hologram 320 of the object and define the equation. The 3D image may be obtained using a stereo camera or by drawing the object using a graphic tool.

The device 300 may receive a parameter value defining a spatial light modulator 330 as the first parameter value. The spatial light modulator 330 may modulate a signal of light incident to the holographic content and reconstruct the hologram 320 from the holographic content. Whether an identical holographic content is displayed to the observer may be determined based on a type and a characteristic of the spatial light modulator 330.

The spatial light modulator 330 may change a direction of the hologram 320 based on light phase processing. Also, the spatial light modulator 330 may electrically record the holographic content in the incident light and show the holographic content to the observer. The parameter value of the spatial light modulator 330 may include an optical wavelength, a pixel size of the holographic content, and a number of holographic content samplings.

The device 300 may receive a display parameter value defining a characteristic of the display as the first parameter value. The display may project the light in which the holographic content is recorded. When the light reaches the eyes of the observer, the observer may recognize a form of the hologram 320. The display parameter value may include a pixel pitch, a number of pixels, and signal format.

The device 300 may perform optical modeling on a change in the hologram 320 occurring due to adjusting the first parameter value. The device 300 may analyze the characteristic of the spatial light modulator 330 and the display and define, as an equation, a form of the object expressed by the hologram 320.

The device 300 may reconstruct the hologram 320 from the holographic content using the spatial light modulator 330. Here, a projection optical system 340 may enlarge a size of the hologram 320 based on the width between the eyes of the observer viewing the display and project the hologram 320 to the eyes.

The device 300 may adjust the first parameter value to be the second parameter value by providing the hologram 320 on the display and receiving feedback through a feedback based interface 310. The feedback may be information on whether the hologram 320 provided on the display is identical to the hologram 320 on which modeling is performed to calculate the holographic content.

When differing feedback is received from each of a plurality of displays, the device 300 may calculate an average of the feedback and prepare a standardized feedback to adjust the first parameter value to the second parameter value.

The device 300 may determine whether the hologram 320 provided to the display corresponds to a predetermined band of the holographic content or the characteristic of the spatial light modulator 330.

The device 300 may determine whether to adjust the first parameter value to the second parameter value based on a result of the determining. The device 300 may determine whether the hologram 320 is displayed on the display and adjust the first parameter value to the second parameter value based on the feedback.

The device 300 may adjust the first parameter value by receiving feedback reflecting an individual characteristic of the observer. For example, the device 300 may adjust the first parameter value by receiving the width between the eyes of the observer.

The device 300 may enable a process of CGH based holographic generation and a process of hologram reconstruction to be connected online and thus, adjusting parameter values may be performed in a form of feedback.

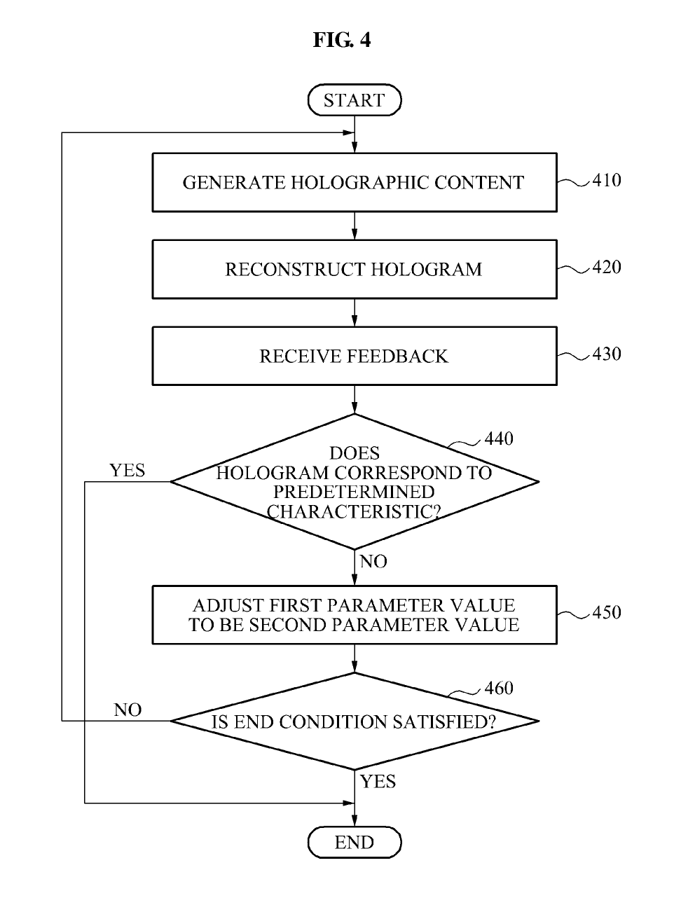

FIG. 4 is a flowchart illustrating a method for providing digital holographic content reconstruction verification according to an embodiment of the present invention.

Referring to FIG. 4, in operation 410, a device for digital holographic content reconstruction verification may generate a holographic content by receiving a first parameter value and calculating a CGH. The device may calculate the CGH by obtaining a 3D image of an object to be shown as a hologram. The device may calculate each pixel value of the 3D image based on an equation defined in a process of modeling. The device may perform optical modeling on a change in the hologram occurring due to adjusting the first parameter value. The 3D image may be obtained using either a stereo camera, or a stereoscopic image editing tool for a virtual object.

The device may receive a spatial light modulator defining a characteristic of a spatial light modulator as the first parameter value. The spatial light modulator may be a device of modulating a signal of light incident to the holographic content and reconstructing the hologram from the holographic content. Whether the hologram shown to the observer is displayed may be determined based on a type and the characteristic of the spatial light modulator. The spatial light modulator may electrically record the holographic content in the incident light to show the observer the holographic content. The spatial light modulator parameter value may include an optical wavelength, a pixel size of the holographic content, and a number of holographic content samplings.

The device may receive a display parameter value defining a characteristic of the display as the first parameter value. The display parameter value may include a pixel pitch, a number of pixels, and signal format. The device may generate the holographic content in a form of a video signal by substituting the first parameter value in the equation.

In operation 420, the device may reconstruct the hologram by applying an optical method after generating the holographic content. The device may enlarge a size of the hologram based on a width between eyes of the observer viewing the display and project the hologram to the eyes.

In operation 430, the device may receive feedback from the display after providing the hologram to the display. The feedback may be information on whether the holographic content calculated based on the first parameter value is played on the display, in a form of the hologram on which modeling is performed.

The device may determine items to be verified including a size and image quality of the hologram, and receive information, as the feedback, on whether the items are satisfied.

When differing feedback is received from each of a plurality of displays, the device may calculate an average of the feedback and prepare a standardized feedback to adjust the first parameter value to the second parameter value.

In operation 440, the device may determine whether the hologram corresponds to a predetermined characteristic based on the feedback. The device may determine whether the hologram is displayed on the display.

Also, the device may determine whether the hologram provided to the display corresponds to a predetermined band of the holographic content or the characteristic of the spatial light modulator.

When feedback indicating that the hologram is not displayed is received, the device may determine that the band of the holographic content does not correspond to a band of the hologram.

In operation 450, the device may adjust the first parameter value to the second parameter value by determining whether to adjust the first parameter value based on a result of the determining. The device may directly receive the second parameter value of the hologram and adjust the first parameter value. The device may adjust the first parameter value by receiving feedback reflecting an individual characteristic of the observer. The device may adjust the first parameter value by receiving the individual characteristic, for example, a width between the eyes of the observer.

In operation 460, the device may determine whether an end condition is satisfied after the first parameter value is adjusted. The end condition may be a condition under which the hologram is optimized. The device may repeat operation 410 of generating the holographic content, and optimize and play the hologram by continuously receiving the feedback.

According to an embodiment of the present invention, a hologram may be optimized to be suitable for characteristics of a display and an observer by automatically adjusting parameter values used to generate a holographic content based on feedback on the hologram.

Further, when the hologram is reconstructed in an integrated kiosk, verification of the holographic content may be repeated in a short period of time by successively performing modification of the holographic content based on the feedback.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A device for feedback based digital holographic content reconstruction verification, the device comprising:
a generator to generate a holographic content by receiving a first parameter value and calculating a Computer-Generated Hologram (CGH);
a reconstructor to reconstruct a hologram from the holographic content using a spatial light modulator; and
a feedback based interface to adjust the first parameter value to be a second parameter value by providing the hologram to a display and receiving feedback from the display.

2. The device of claim 1, further comprising:
a modeling unit to perform optical modeling on a change in the hologram occurring due to adjusting the first parameter value to be the second parameter value.

3. The device of claim 1, wherein the generator receives a spatial light modulator parameter value defining a characteristic of the spatial light modulator as the first parameter value.

4. The device of claim 1, wherein the generator receives a display parameter value defining a characteristic of the display as the first parameter value.

5. The device of claim 1, wherein the generator generates the holographic content in a form of a video signal.

6. The device of claim 1, wherein the reconstructor enlarges a size of the hologram based on a width between eyes of an observer viewing the display and projects the hologram to the eyes of the observer.

7. The device of claim 1, wherein, when differing feedback is received from each of a plurality of displays, the feedback based interface calculates an average of the differing feedback and prepares a standardized feedback for adjusting the first parameter value to be the second parameter value.

8. The device of claim 1, wherein the feedback based interface determines whether the hologram provided to the display corresponds to a predetermined band of the holographic content or a characteristic of the spatial light modulator and determines whether to adjust the first parameter value to the second parameter value based on a result of the determining.

9. The device of claim 1, wherein the feedback based interface determines whether the hologram is displayed on the display and adjusts the first parameter value to be the second parameter value when the hologram is determined not to be displayed.

10. The device of claim 1, wherein the feedback based interface adjusts the first parameter value by receiving feedback reflecting an individual characteristic of an observer.

11. A method for providing feedback based digital holographic content reconstruction verification, the method comprising:
generating a holographic content by receiving a first parameter value and calculating a Computer-Generated Hologram (CGH);
reconstructing a hologram from the holographic content using a spatial light modulator; and
adjusting the first parameter value to be a second parameter value by providing the hologram to a display and receiving feedback from the display.

12. The method of claim 11, further comprising:
performing optical modeling on a change in the hologram occurring due to adjusting the first parameter value to the second parameter value.

13. The method of claim 11, further comprising:
receiving a spatial light modulator parameter value defining a characteristic of the special light modulator as the first parameter value.

14. The method of claim 11, further comprising:
receiving a display parameter value defining a characteristic of the display as the first parameter value.

15. The method of claim 11, wherein the generating comprises generating the holographic content in a form of a video signal.

16. The method of claim 11, further comprising:
enlarging a size of the hologram based on a width between eyes of an observer viewing the display and projecting the hologram to the eyes of the observer.

17. The method of claim 11, wherein, when differing feedback is received from each of a plurality of displays, the adjusting comprises calculating an average of the differing feedback and preparing a standardized feedback for the adjusting.

18. The method of claim 11, wherein the adjusting comprises determining whether the hologram provided to the display corresponds to a predetermined band of the holographic content or a characteristic of the spatial light modulator and determining whether to adjust the first parameter value to be the second parameter value based on a result of the determining.

19. The method of claim 11, wherein the adjusting comprises determining whether the hologram is displayed on the display and adjusting the first parameter value to be the second parameter value when the hologram is determined not to be displayed.

20. The method of claim 11, wherein the adjusting comprises adjusting the first parameter value by receiving feedback reflecting an individual characteristic of an observer.
